(19) United States
(12) Patent Application Publication
(10) Pub. No.: US 2006/0029106 A1
(43) Pub. Date: Feb. 9, 2006

(54) System and method for providing content-based instant messaging

(75) Inventors: Maximilian A. Ott, Pennington, NJ (US); Jaime Gomezjurado, Jersey City, NJ (US); Daniel J. Reininger, Princeton, NJ (US); Leslie French, Princeton, NJ (US)

Correspondence Address: WILMER CUTLER PICKERING HALE AND DORR LLP, 399 PARK AVENUE, NEW YORK, NY, 10022, US

(73) Assignee: Semandex Networks, Inc., Princeton, NJ (US)

(21) Appl. No.: 11/151,966

(22) Filed: Jun. 14, 2005

Related U.S. Application Data
(60) Provisional application No. 60/579,952, filed on Jun. 14, 2004.

(51) Int. Cl. H04J 3/12

(52) U.S. Cl. 370/522

(57) ABSTRACT

In accordance with the present invention, systems and methods for providing content-based instant messaging are provided, which allows users to send and receive messages based on whether the recipient fits the criteria specified by the content of the message. The system and method of the present invention identifies recipients by matching the content of the message to the interest, or expertise profile of the recipient. By enabling individuals to communicate with people that fulfill a certain criteria, it will enable the autonomous creation of communities of interest, and facilitate the identification of “experts” without the need to create a centralized expertise database.

### CROSS-REFERENCE TO RELATED APPLICATION

This application claims the benefit under 35 U.S.C. § 119(e) of U.S. Provisional Patent Application No. 60/579,952, filed Jun. 14, 2004, which is hereby incorporated by reference herein in its entirety.

### FIELD OF THE INVENTION

The present invention relates to a system and method for providing content-based instant messaging. More particularly, the invention relates to a system and method for providing content-based instant messaging that enables users to send and receive messages based on whether the recipient fits the criteria specified by the content of the message.

### BACKGROUND OF THE INVENTION

Instant messaging (IM) has successfully crossed from the consumer world into the corporate world. Companies, such as Reuters and IBM, provide enhanced IM solutions tailored to the requirements of the workplace. However, the basic principle remains—IM applications allow a user to communicate with a list of other users. While it is easy for a person to set-up what has become known as a “buddy” list, it is generally significantly more difficult to build a list of all the people in a company or enterprise who have certain characteristics, for example, they share a particular interest, are experts in a specific topic, know about a certain customer, etc. Present implementations of IM cannot accommodate this approach. At present, IM is a tool used to send messages to all the people on a specific list. There is a need for a tool that enables a user to communicate with all the people fulfilling a certain criteria—friends or “buddies” being just one of them.

“Communities of Interest” (COIs) are a tool for facilitating information exchange within an organization through collaboration and expertise sharing. However, establishing these communities and, more importantly, maintaining them has proven to be extremely difficult. Most approaches use “meeting place” abstractions, such as regular face-to-face meetings, virtual rooms, or online forums, for practitioners to meet and interact. As with any network, the value of a COI grows with the number of members. It is therefore always a challenge to first grow these communities to a critical mass, and if they do reach it, to maintain their focus and keep membership. In fact, in a dynamic business environment new topics of interest will constantly emerge, and existing ones will lose their importance. This will either require the constant formation and careful growth of new communities, or the equally difficult task of steering the focus of existing groups to maintain viability. There is a need for a tool to facilitate the creation, maintenance and support of COIs.

### SUMMARY OF THE INVENTION

In accordance with the present invention, systems and methods for content-based instant messaging are provided, which allows users to send and receive messages based on whether the recipient fits the criteria specified by the content of the message. The system and method of the present invention identifies recipients by matching the content of the message to the interest, or expertise profile of the recipient. By enabling individuals to communicate with people that fulfill a certain criteria, it will enable the autonomous creation of communities of interest, and facilitate the identification of “experts” without the need to create a centralized expertise database.

In accordance with some embodiments of the present invention, a method for content-based instant messaging is provided. The method comprises receiving at least one profile that includes an interest or an expertise of at least one user, receiving a message including content, comparing the content of the message to the at least one profile to determine whether the content matches the at least one profile and transmitting the received message to the at least one user when the content of the message matches the at least one profile.

In accordance with other embodiments of the present invention, a method for routing an instant message that includes content based upon the content of the instant message is provided. The method comprises receiving at least one profile that includes an interest or an expertise of at least one user, receiving a message, comparing the content of the message to the at least one profile to determine whether the content matches the at least one profile and routing the received message to the at least one user when the content of the message matches the at least one profile.

In accordance with other embodiments of the present invention, a method for creating a knowledge base of information based upon messages routed within a network is provided. The method comprises receiving profiles wherein each of the profiles includes a respective interest or expertise of a plurality of users, receiving a first message wherein the first message includes content comprising a query, routing the first message to one of the plurality of users based in part on the content of the first message and one of the profiles, receiving a second message wherein the second message includes content comprising a response to the query of the first message, and storing the first and second messages to create a knowledge base of information.

In accordance with other embodiments of the present invention, a system for content-based instant messaging is provided. The system comprises at least one profile repository for storing profiles comprising respective interests or expertise of a plurality of users, a content analyzer for receiving a message including content and comparing the content of the message to the profiles to determine whether the content matches at least one of the plurality of profiles, a content based network for transmitting the received message to at least one user when the content of the message matches the at least one of the plurality of profiles of the at least one user.

In accordance with other embodiments of the present invention, a computer-implemented method for content-based instant messaging is provided. The computer implemented method comprises receiving at least one profile that includes an interest or an expertise of at least one user, receiving a message including content, comparing the content of the message to the at least one profile to determine whether the content matches the at least one profile, and transmitting the received message to the at least one user when the content of the message matches the at least one profile.

In accordance with other embodiments of the present invention, a computer implemented method for routing an instant message that includes content based upon the content of the instant message is provided. The computer implemented method comprises receiving at least one profile that includes an interest or an expertise of at least one user, receiving a message, comparing the content of the message to the at least one profile to determine whether the content matches the at least one profile, and routing the received message to the at least one user when the content of the message matches the at least one profile.

In accordance with other embodiments of the present invention, a computer implemented method for creating a knowledge base of information based upon messages routed within a network is provided. The computer implemented method comprises receiving profiles wherein each of the profiles includes a respective interest or expertise of a plurality of users, receiving a first message wherein the first message includes content comprising a query, routing the first message to one of the plurality of users based in part on the content of the first message and one of the profiles, receiving a second message wherein the second message includes content comprising a response to the query of the first message, and storing the first and second messages to create a knowledge base of information.

In accordance with other embodiments of the present invention, an article of manufacture is provided that comprises a computer readable medium that stores computer executable instructions for causing a computer system to receive at least one profile that includes an interest or an expertise of at least one user, receive a message including content, compare the content of the message to the at least one profile to determine whether the content matches the at least one profile, and transmit the received message to the at least one user when the content of the message matches the at least one profile.

In accordance with other embodiments of the present invention, an article of manufacture is provided that comprises a computer readable medium that stores computer executable instructions for causing a computer system to receive at least one profile that includes an interest or an expertise of at least one user, receive a message, compare the content of the message to the at least one profile to determine whether the content matches the at least one profile, and route the received message to the at least one user when the content of the message matches the at least one profile.

In accordance with other embodiments of the present invention, an article of manufacture is provided that comprises a computer readable medium that stores computer executable instructions for causing a computer system to receive profiles wherein each of the profiles includes a respective interest or expertise of a plurality of users, receive a first message wherein the first message includes content comprising a query, route the first message to one of the plurality of users based in part on the content of the first message and one of the profiles, receive a second message wherein the second message includes content comprising a response to the query of the first message, and store the first and second messages to create a knowledge base of information.

Thus, there has been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and description matter in which there is illustrated preferred embodiments of the invention.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements.

FIG. 1 illustrates an embodiment of a content-based instant messaging environment.

FIG. 2 illustrates an embodiment of system components for providing content-based instant messaging according to an embodiment of the present invention.

FIG. 3 illustrates an embodiment of a content-based network deployment.

FIG. 4 illustrates an embodiment of a screenshot of a messaging application using a template based categorizer.

FIG. 5 illustrates an embodiment of a system for implementing the present invention.

### DETAILED DESCRIPTION

In the following detailed description, numerous specific details are set forth regarding the system and method of the present invention and the environment in which the system and method may operate, etc., in order to provide a thorough understanding of the present invention. It will be apparent, however, to one skilled in the art that the present invention may be practiced without such specific details. In other instances, well-known components, structures and techniques have not been shown in detail to avoid unnecessarily obscuring the subject matter of the present invention. Moreover, various examples are provided to explain the operation of the present invention. It should be understood that these examples are exemplary. It is contemplated that there are other methods and systems that are within the scope of the present invention.

The present invention is directed to a system and method for content-based instant messaging, which allows users to send and receive messages based on whether the recipient fits the criteria specified by the content of the message. Unlike existing IM implementations, the sender is not required to list the target recipients. Instead the system and method of the present invention identifies them by matching the content of the message to the interest, or expertise profile of the recipient. For example, the content-based instant messaging of the present invention will allow a user to send a message to “all colleagues who have experience evaluating companies in Latin America,” “everyone in the Asian office who has had business contacts with company X over the last three years,” or “anyone who knows the clinical trial process for rheumatic drugs” to provide a few examples. By enabling individuals to communicate with people that fulfill a certain criteria, it will enable the autonomous (ad-hoc/spontaneous) creation of communities of interest, and facilitate the identification of “experts” without the need to create a centralized expertise database.

Matching information seekers and providers in a single information space will lead to autonomously emerging communities of interest. If a user's interest is defined as a region in this information space, the common interest among users can be associated with the intersection of their respective interest regions. Therefore, there is no need to explicitly create new communities or COIs, nor is it necessary for a user to find relevant communities, or re-evaluate one's membership in a particular community. If the users' interests or expertise shift, so do their relation with others automatically. In the prior art approach of creating explicit communities with often implicit community definitions, users often find it difficult to discover what communities to associate with, or to realize that the communities to which they already belong, no longer overlap with their interests. In contrast, under the system and method of the present invention, shifting a user's profile, either automatically, or at the user's initiative, will automatically connect the user with the right people, and the right communities.

By capturing an individual's experience and biographical information in a privately maintained profile, and taking advantage of this information when distributing messages to and from the individual, content-based instant messaging will facilitate the search for “experts.” Prior art knowledge management solutions require a sender looking for “knowledge/expertise” from other individuals to first assemble a recipient list. This list is formed by querying a centralized database containing the knowledge or expertise profile of all users. Building a centralized expertise database is not only difficult and poses a scalability problem, but it also creates a crucial privacy problem. Exposing these expertise profiles to everyone would face considerable opposition from their owners, even if it is restricted to internal use only. In contrast with prior art solutions, content-based instant messaging does not require the creation of a centralized expertise database, and individuals do not need to either create distribution lists, or make their profiles public.

By facilitating expertise search and the creation of autonomous communities of interest, content-based instant messaging will allow organizations to tap the knowledge within them to navigate in an ever changing business environment. Companies nowadays operate in a constantly changing network of customers, suppliers, and strategic partners. Efficient communication is clearly a strategic advantage, but only if information flows can be successfully managed at the same time. The present invention facilitates the efficient flow of information.

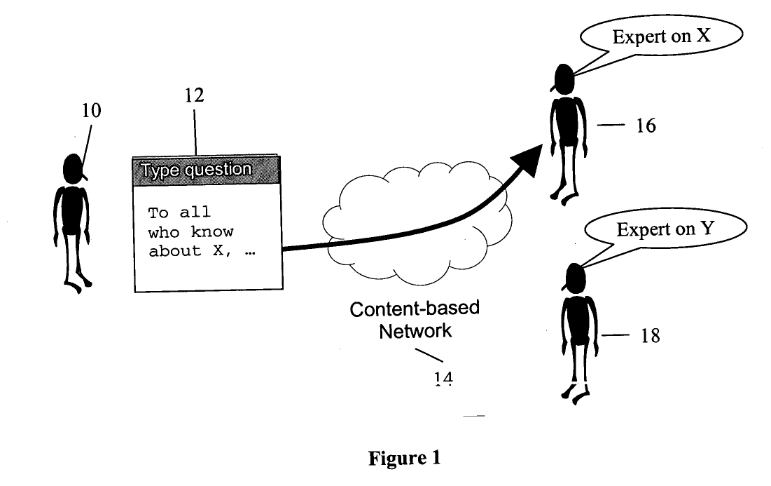

Referring now to the drawings, and initially to FIG. 1, there is illustrated the basic concept of content-based instant messaging. A user 10 sends a message 12 into a content-based network 14 where the message itself does not contain a specific address. Potential recipients 16 and 18 are known to the network by their specific interest, or expertise profile. The content-based network 14 will then deliver a message to only those users whose profile matches the content of the message.

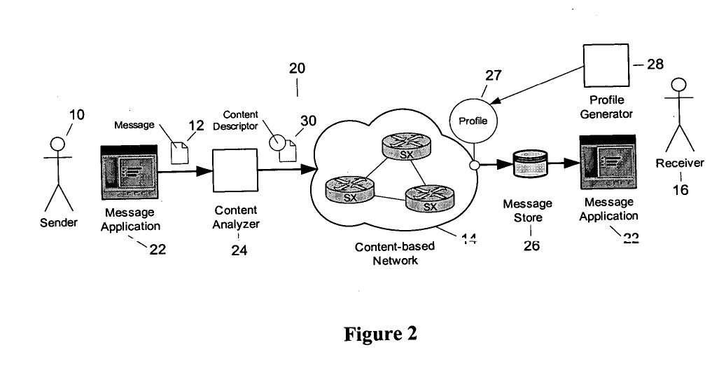

FIG. 2 shows an embodiment of a system 20 for providing content-based instant messaging according to the present invention. The system includes 1) a component to create and send a message, referred to herein as a “Message Application” 22; 2) a content analyzer 24 which adds a content descriptor to the message; 3) the content-based routing network 14 to deliver a message to all interested users; 4) a component 26 to store the message; 5) the Message Application 22 to present the received messages to the user, which could be the same or different from the Message Application 22 that creates and sends a message and, which, in at least one embodiment, may be integrated with the component to create and send a message; and 6) a profile generator 28, which either automatically or with the help of the user, creates a profile representing the interest, or expertise of the user. Each component is described in detail below.

Messaging Application

A service or application built on the foundations of the system and method of the present invention aims to become part of the daily routine of the knowledge worker. For this to happen, its interface to the user should be intuitive and already part of his workflow and toolset; this will help minimize the user's “learning curve” and accentuate the system's benefits. One solution would be to allow the user to ask a question from an application; this would imply that new functionality to ask the question would need to be added to the application. For instance, an application to view X-ray images may allow the user to circle a particular part of the image and to create, for example, a “what is this?” question, to allow a user to highlight the name of a company in a report and formulate, for example, a “who is in contact with this company?” question.

An alternate embodiment would be to integrate a content-based messaging front-end to email, the most familiar messaging application for many users. For example, Microsoft® Outlook, with its well-known “add-on” mechanism allows for the addition of new functionality in a familiar context. Those skilled in the art would appreciate and understand this “add-on” mechanism and how to incorporate new features with Microsoft® Outlook. However, it should be understood by those skilled in the art that the use of Microsoft® Outlook is an example only as other messaging applications are available and applicable.

Content Analyzer

To “understand” the request and translate it to a form that can be directly used by a content-based network 14, a content descriptor 30 needs to be extracted from the message. More specifically, the content analyzer 24 will analyze the message 12 and create a “content descriptor” 30, which will describe the content of the message 12 for subsequent processing using, for example, one or more XML schemas. The content descriptor 30 and the original message 12 will be wrapped into a packet consisting of a header and a body. The header contains the content descriptor(s) 30, and other meta data, including but not limited to the sender's identity, while the body will contain the original message 12. This packet will then be injected into the content-based network 14 to be forwarded to the appropriate receivers.

One embodiment of the present invention utilizes advances in content-categorization and the work already performed by standard bodies, such as OASIS, and industry consortia, such as HR-XML, to define XML standards, lexicons, message schemas and ontologies as the foundation for metadata.

While automatic content categorization and automatic profile creation are very difficult problems in the general case, an embodiment of the system and method of the present invention allows users to create messages from pre-defined templates. This is a very user-friendly approach for environments with clearly defined types of messages, such as requests for specific information on certain entities (e.g., valuation of companies, cost of equity, balance sheet strength, debt ratings, etc.). Without typing and with just a few clicks of the mouse a user can easily send a message. Besides the convenience for the user, a template-based approach simplifies the categorization of the message as supporting information that can be embedded in the template.

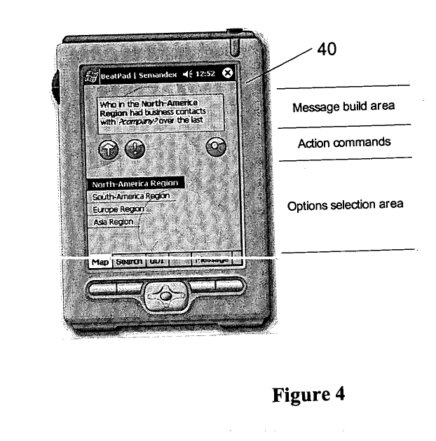

As illustrated in FIG. 4, after selecting a template the user replaces the template's placeholders with the kind of information 40 sought. For instance, the first placeholder in FIG. 4 allows the user to restrict the geographic region for which the question is valid. In this embodiment, and for illustrative purposes only, the user can only select from a pre-set list. It should be understood, however, that this is just an example of how a user may choose information as there are different approaches as understood by those skilled in the art. For example, alternate embodiments of the system and method may include a topic-specific content categorizer which will automate the content analysis function and allow for a greater variety of messages.

Content-Based Routing

Unlike traditional networks, where data packets are delivered according to a low-level IP address or set of addresses, Content-Based Routing (CBR) networks distribute and deliver packets based on i) a content descriptor that represents the information content of the packet, and ii) interest profiles which describe the receiver's information needs. These profiles constitute the equivalent of traditional routing tables. End users and producers (e.g., software applications, terminals, individuals, etc.) register with the network, or more precisely, an access router, by providing a profile. The access router merges this profile with those of all the other locally registered end-points, to effectively build a “community” profile. The router itself then registers this community profile with all its neighboring routers, thus continuing the merging process towards the core of the network. Like the Internet, this solution scales to a large number of users as each router only needs to make as many forwarding decisions per packet as it has immediate neighbors. Adding a user will only add linear load to that router, and no other element in the system.

It should be noted, that profile aggregation hides the profile of a specific user. A community profile describes the interest of the community as an aggregate which makes it difficult to isolate a single user's interest, thus obviating individual user privacy issues. This is especially true for communities with similar or correlated interests.

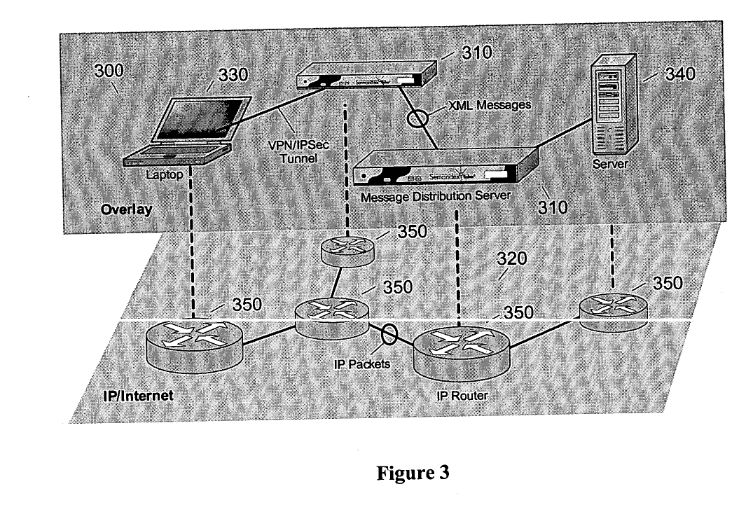

One embodiment of the CBR concept is the Semandex Netlink system, which is available from the assignee of the present application. It operates on top of an existing IP network (e.g., the Internet, a corporate or service Intranet, or a secured network). FIG. 3 depicts a typical implementation 300 where Netlink connects information providers and users through a network that resembles the Internet in architecture and scalability. A Netlink network includes content routers 310 (often also referred to as Message Distribution Servers) and terminals, such as user facing laptops 330 or server 340. Connections between the elements in the overlay network are realized as tunnels through the underlying IP network 320 (comprising IP routers 350), using technologies such as VPN, IPSec, or IP-in-IP, or other similar technologies which are well-known to those skilled in the art. Applications residing on terminals 330 or 340 connect to the nearest Message Distribution Server (MDS) 310. If the application is interested in receiving messages it sends a profile, which the MNS 310 combines with all the profiles it received from other connected terminals. An MDS 310 is periodically exchanging this combined profile together with profiles it learned from other connected MDSs 310 with all the MDSs 310 it is directly connected, thus allowing it to build a profile for each link. If a terminal 330 or server 340 wants to send a message it simply forwards it to the MDS 310 to which it is connected. The MDS 310, in turn, compares the content descriptor contained in the message with the profiles associated with every direct connection and forwards it along the subset of connections where the respective profile matches the content descriptor. If the receiver is an MDS 310, it will employ the same algorithm creating a hop-by-hop distribution mechanism with each hop, or MDS 310 having to scale only with the number of immediate neighbors, and not with overall number of users as is the case for centralized broker solutions. If it is a terminal 330 or 340 it will forward it to the respective application.

In line with industry trends, the content descriptors and the interest profiles are represented in XML in one embodiment of the present invention. It should be understood by those skilled in the art that representations other than XML can be used. While the NetLink CBR router can process any valid XML, the communicating parties need to agree on a common schema(s) so that the description can be semantically matched against the interest profiles. This is similar to using the telephone network where the network can connect any telephone, but a meaningful conversation requires the user to agree on a language(s) which both sides speak and understand.

As the profile can easily be changed dynamically, a CBR network is ideal for services in which end-user locations vary with time, and information delivery needs are driven by content affinity rather than physical address. Knowledge management is one such service. Knowledge management allows an organization to “know what it knows” and to “make this knowledge available to people who need to know it when they need to know it.”

Storage and Presentment of Message

The messages exchanged among content-based messaging users are themselves a source of organizational knowledge. Capturing the responses to a query such as “what is the best way of valuing a company that has a complex capital structure and is close to bankruptcy?” in a data repository can make it possible for the query and its responses to be accessed again by other parties in the future who are interested in answers to the same question. By maintaining a repository of queries and responses, the organizational knowledge is preserved and a ready source of information for the organization is created. This information can be captured in a variety of ways. For example, it could become part of a Blog, or could be stored in a database (e.g. XML, Oracle, etc.). The method used is unimportant as long as the thread of the query and responses is maintained, the embedded content-descriptor is also archived and the information can be easily accessed by a software agent.

For message presentment to the recipient the same messaging application described earlier can be used, or it can be integrated with a content-based messaging front-end to email, the most familiar messaging application for many users. For example, Microsoft® Outlook, with its well-known “add-on” mechanism allows for the addition of new functionality in a familiar context. Those skilled in the art would appreciate and understand this “add-on” mechanism and how to incorporate new features with Microsoft® Outlook. However, it should be understood that the use of Microsoft® Outlook is an example only as other messaging applications are available and applicable.

Profile Generation

As indicated earlier, the CBR matches messages to users' profiles to route the message accordingly. There are different approaches to build the profiles, from manual creation by the user to automatically building the profiles based on the users' personal characteristics.

In one embodiment, a profile template can be created from an employee's job description. This template can then be personalized, or adapted to the job at hand. This may be automatically determined from the employee's work context, such as assigned customers, state of specific applications, or records currently viewed. An alternative embodiment may require the user to provide the necessary information. Such a solution allows a user to check, and if needed, change the current profile, especially if it is initially created by an automatic process.

Rather than waiting for users to create their own profiles, which may slow adoption and diminish the usability of the system for those who do create them, an embodiment of the invention can also create and update user profiles automatically. Based on an analysis of the user's email and other private information, the system will create a profile for the user that specifies the type of information/content the user is interested in and comprises her area of expertise. The system and method of the present invention allows knowledge workers to modify or augment their profiles as they see fit. User profiles are designed to be dynamic; not only can the user modify them, but over time, the system and method will update the profiles based on the user's messaging information and other private data. Individual user profiles are the property of the user and are not seen by other members of the knowledge network. User profiles are aggregated at the nearest network router/messaging center; only these aggregates are visible to other network points.

In an embodiment of the invention, when new information (e.g., a message/query) that matches an individual's profile becomes available, the content-based network 14 can send the information immediately to the user without the need of a new query. Therefore, in this embodiment, content-based instant messaging users are always updated with the knowledge they seek, and can share their knowledge with others looking for it.

An alternate embodiment of content-based instant-messaging takes advantage of the systematic representation of the posted query created by the content analyzer 24. Queries sent using content-based instant messaging-and their responses can be stored to form a repository of organizational knowledge. Domain specific software agents could be created to tap these repositories and other knowledge sources within an organization. By publishing a domain specific profile these software agents would attract queries within their programmed expertise. For instance, domain specific software agents can either turn the question into a query on a database, or retrieve a previously posted message to similar questions. In addition, a community based feedback system (such as relevance voting) can elevate some of the answers to “information nuggets,” or “lessons learned,” which can subsequently be served, or referred to by special agents. Akin to a multi-level support service, the messaging service can be configured into a two phase system. Initially, a question is only delivered to software agents. Only if their answers are not sufficient to solve the problem at hand will the inquirer be able to post the same question, or a revised version, to the human experts connected to the network. This can lead to a system capable of handling many messages without overwhelming the human experts.

### Sample Embodiments

Over the last 15 years a significant body of work has shown that communities of interest (COIs), which are a group of people that regularly come together to learn from one another based on their common interests, are an effective way to manage knowledge in organizations. VCOIs are COIs whose members communicate with one another primarily through electronic means and are generally found in organizations that are large and geographically disperse. To date there is very little IT support for VCOIs; email, phones, portals are the most common means of communication.

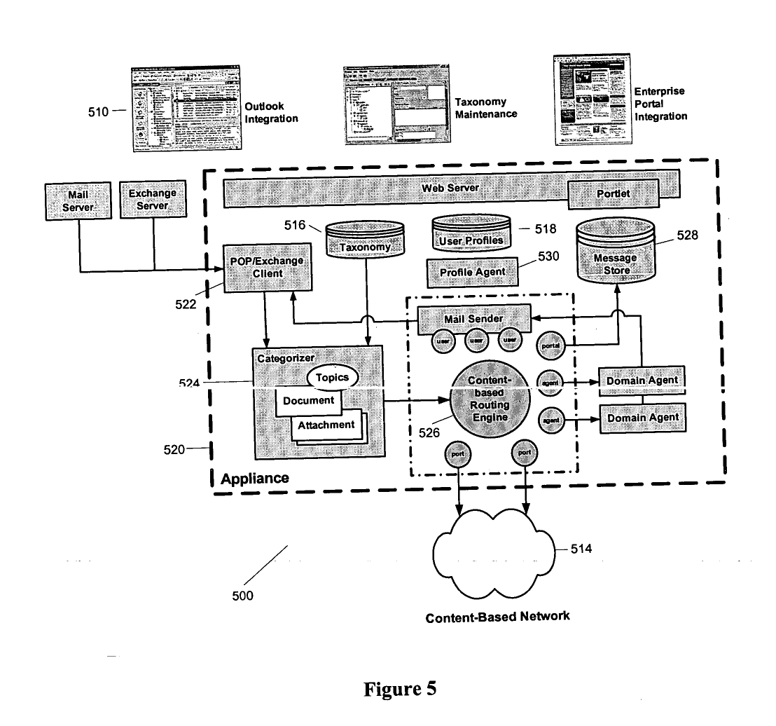

An embodiment of the invention, as illustrated in FIG. 5, is a Knowledge Network (KN) 500. The KN 500 will inherently enable the spontaneous creation of VCOIs. KN messaging provided through, for example, Microsoft® Outlook will let members exchange information based on their user profiles. A data repository will house all the information exchanged by the VCOI's members tagged in, for example, XML for easy retrieval.

KN users interact with one another and exchange knowledge pertinent to their work and areas of interest. Over time, the interactions of subgroups of users can grow more continuous, thus creating de-facto VCOIs. These spontaneous VCOIs can then choose to either formatize their arrangement or take advantage of KN's VCOI support features, in the form of a community portal, or continue exchanging information by writing and responding to queries in their area of interest.

FIG. 5 shows in block diagram form an embodiment of the KN 500, which provides an easy to deploy, turn-key solution. The KN 500 comprises components for implementing content-based instant messaging according to an embodiment of the present invention: a messaging interface(s) 510, a content categorizer 524, a content-based routing network 514, database 516 for storing the taxonomy of the specific domain of operation, database 518 for user profiles and database 528 for messages exchanged. The KN can also contain domain specific software agents such as those described earlier. In this embodiment, the interface for a user to this system is through Microsoft® Outlook (top left). Specifically, an “add-in” is deployed through a companies' Exchange server. An alternative embodiment will take advantage of the increasing capability of Outlook to integrate web-based components. Moreover, the same functionality can be provided through a web portal.

A POP/Exchange client 522 on an appliance 520 receives the messages created by the users. The message will then be processed by a categorizer 524, which will add a content descriptor. The message will then be injected into a content-based routing network such as NetLink or some other embodiment of a content-based routing network. The appliance 520 will include the initial routing engine 526 which serves the local community and connects to upstream routers to connect to the rest of the community. A copy of each message is kept in a message store 528 to provide access to historic information, as well as allowing an administrator to analyze the utilization of the system.

A profile agent 530 will help the users to create their initial profiles, and track their changing interest and expertise. Depending on the integration with other applications, the profile agent 530 will rely on various “context adapters” (Profile Agent) to gain a better understanding of the user's activities. In one embodiment, this may be restricted to observing user's messages, potentially gaining access to other email messages, and other information objects accessed by the user in the course of his activities. A web-based interface to the Profile Agent will allow the users to observe and correct their respective profiles.

Both message categorization and profile creation require a common base ontology. The ongoing stream of messages is used to refine the ontology continuously to best reflect the current interests of its user community. One tool for this task is Protégé, an ontology editor and knowledge acquisition system developed by Stanford University, a description of which is available at The Protégé Ontology Editor and Knowledge Acquisition System, http://protege.stanford.edu, which description is expressly incorporated herein by reference. Pluggable “domain agents” can be introduced at a later stage to answer common questions whose answer can be found in specific data repositories.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow.

We claim:

1. A method for content-based instant messaging comprising:
receiving at least one profile that includes an interest or an expertise of at least one user;
receiving a message including content;
comparing the content of the message to the at least one profile to determine whether the content matches the at least one profile; and
transmitting the received message to the at least one user when the content of the message matches the at least one profile.

2. The method of claim 1 wherein receiving at least one profile further comprises receiving a plurality of profiles wherein each of the plurality of profiles includes an interest of an expertise of one of a plurality of users.

3. The method of claim 2 wherein the receiving of a plurality of profiles enables automatic creation-of communities of interest.

4. The method of claim 2 wherein the receiving of a plurality of profiles facilitates identification of experts.

5. The method of claim 1 wherein the received message includes a content descriptor and comparing the content of the received message further comprises comparing the content descriptor to the at least one profile to determine whether the content matches the at least one profile.

6. The method of claim 1 further comprising using a content categorizer to automatically create a content descriptor from the content and wherein comparing the content of the received message further comprises comparing the content descriptor to the at least one profile to determine whether the content matches the at least one profile.

7. The method of claim 1 wherein the receiving a message further comprises receiving a message including content wherein the message was created from pre-defined templates.

8. The method of claim 7 wherein the created message facilitates categorization by including embedded information in the pre-defined template.

9. The method of claim 8 wherein the created message is created using a preset list of categories.

10. The method of claim 1 wherein the at least one profile is automatically created based on an analysis of information regarding a user.

11. The method of claim 10 wherein the information used to create the at least one profile includes at least one of a user's email and job description.

12. The method of claim 10 wherein the at least one profile is dynamically updated based on the user's messaging information and the user's private data.

13. A method for routing an instant message that includes content based upon the content of the instant message comprising:
receiving at least one profile that includes an interest or an expertise of at least one user;
receiving a message;
comparing the content of the message to the at least one profile to determine whether the content matches the at least one profile; and
routing the received message to the at least one user when the content of the message matches the at least one profile.

14. A method for creating a knowledge base of information based upon messages routed within a network comprising:
receiving profiles wherein each of the profiles includes a respective interest or expertise of a plurality of users;
receiving a first message wherein the first message includes content comprising a query;
routing the first message to one of the plurality of users based in part on the content of the first message and one of the profiles;
receiving a second message wherein the second message includes content comprising a response to the query of the first message; and
storing the first and second messages to create a knowledge base of information.

15. The method of claim 14 wherein the second message is routed to one of the plurality of users that sent the first message.

16. The method of claim 14 wherein the second message is routed to each of the plurality of users that have expressed an interest in the content included in the second message.

17. The method of claim 14 wherein the first and second messages are stored in a Blog.

18. The method of claim 14 wherein the first and second messages are stored in a database.

19. The method of claim 14 further comprising routing subsequent messages that include content that match a user's profile when the subsequent messages become available.

20. The method of claim 14 further comprising automatically creating of communities of interest based on-the received profiles.

21. The method of claim 17 further comprising facilitating identification of experts based on the received profiles.

22. A system for content-based instant messaging comprising:
at least one profile repository for storing profiles comprising respective interests or expertise of a plurality of users;
a content analyzer for receiving a message including content and comparing the content of the message to the profiles to determine whether the content matches at least one of the plurality of profiles;
a content based network for transmitting the received message to at least one user when the content of the message matches the at least one of the plurality of profiles of the at least one user.

23. The system of claim 22 wherein the received message includes a content descriptor and the content analyzer further comprises comparing the content descriptor to the profiles to determine whether the content matches at least one of the plurality of profiles.

24. A computer-implemented method for content-based instant messaging comprising the steps of:
receiving at least one profile that includes an interest or an expertise of at least one user;
receiving a message including content;
comparing the content of the message to the at least one profile to determine whether the content matches the at least one profile; and
transmitting the received message to the at least one user when the content of the message matches the at least one profile.

25. A computer implemented method for routing an instant message that includes content based upon the content of the instant message comprising the steps of:
receiving at least one profile that includes an interest or an expertise of at least one user;
receiving a message;
comparing the content of the message to the at least one profile to determine whether the content matches the at least one profile; and
routing the received message to the at least one user when the content of the message matches the at least one profile.

26. A computer implemented method for creating a knowledge base of information based upon messages routed within a network comprising the steps of:
receiving profiles wherein each of the profiles includes a respective interest or expertise of a plurality of users;
receiving a first message wherein the first message includes content comprising a query;
routing the first message to one of the plurality of users based in part on the content of the first message and one of the profiles;
receiving a second message wherein the second message includes content comprising a response to the query of the first message; and
storing the first and second messages to create a knowledge base of information.

27. The method of claim 26 wherein the second message is routed to one of the plurality of users that sent the first message.

28. The method of claim 26 wherein the second message is routed to each of the plurality of users that have expressed an interest in the content included in the second message.

29. An article of manufacture comprising a computer readable medium that stores computer executable instructions for causing a computer system to:
receive at least one profile that includes an interest or an expertise of at least one user;
receive a message including content;
compare the content of the message to the at least one profile to determine whether the content matches the at least one profile; and
transmit the received message to the at least one user when the content of the message matches the at least one profile.

30. An article of manufacture comprising a computer readable medium that stores computer executable instructions for causing a computer system to:
receive at least one profile that includes an interest or an expertise of at least one user;
receive a message;
compare the content of the message to the at least one profile to determine whether the content matches the at least one profile; and
route the received message to the at least one user when the content of the message matches the at least one profile.

31. An article of manufacture comprising a computer readable medium that stores computer executable instructions for causing a computer system to:
receive profiles wherein each of the profiles includes a respective interest or expertise of a plurality of users;
receive a first message wherein the first message includes content comprising a query;
route the first message to one of the plurality of users based in part on the content of the first message and one of the profiles;
receive a second message wherein the second message includes content comprising a response to the query of the first message; and
store the first and second messages to create a knowledge base of information.

32. The method of claim 31 wherein the second message is routed to one of the plurality of users that sent the first message.

33. The method of claim 31 wherein the second message is routed to each of the plurality of users that have expressed an interest in the content included in the second message.
